(19) United States
(12) Patent Application Publication
(10) Pub. No.: US 2008/0044620 A1
(43) Pub. Date: Feb. 21, 2008

(54) HIGH PILE FABRICS

(76) Inventors: Moshe Rock, Brookline, MA (US); Gadalia Vainer, Melrose, MA (US)

Correspondence Address: FISH & RICHARDSON PC, P.O. BOX 1022, MINNEAPOLIS, MN, 55440-1022, US

(21) Appl. No.: 11/740,629

(22) Filed: Apr. 26, 2007

Related U.S. Application Data
(60) Provisional application No. 60/805,526, filed on Jun. 22, 2006.

(51) Int. Cl. B32B 33/00; D06C 13/00

(52) U.S. Cl. 428/95; 28/159

(57) ABSTRACT

High pile fabrics include textured low shrinkage yarns, e.g. FOY yarns and HOY yarns. In some cases, the fabrics have a pile height of 4.0 mm or greater. Methods of forming such fabrics are also described.

### CROSS-REFERENCE TO RELATED APPLICATIONS

This application claims the benefit from U.S. Provisional Patent Application 60/805,526, filed Jun. 22, 2006.

### TECHNICAL FIELD

This invention relates to high pile knit fabrics.

### BACKGROUND

High pile fabrics (i.e., fabrics having a pile height of at least 4 mm) generally provide good thermal insulation when they are under non-compressed conditions. The level of insulation may be increased by increasing the pile height and maximizing the total bulk of the fabric. However, as the height of high pile fabrics is increased, e.g., to 4.0 mm and higher, the fibers may tend to bend over, reducing total bulk. High pile fabrics may also tend to be relatively heavy, so manufactures often resort to lower fabric density and/or finer pile yarns to reduce weight. This is turn reduces cover factor, which may result in a fabric that is virtually see-through. Thus, it can be difficult to obtain a high pile fiber having a good balance of thermal insulation, weight, density and other properties.

### SUMMARY

The present disclosure features high pile fabrics including textured, low shrinkage yarns, providing a good balance of thermal insulation, weight, density, and other desirable properties such as high resiliency pile, low shrinkage, and high cover factor. Due to their high resilience, the textured, low shrinkage pile yarns tend to resist bending over, thereby providing the fabric with good bulk and insulative properties.

In one aspect, the disclosure features a high pile fabric comprising a fabric body having a technical face and a technical back, at least one of the technical face and technical back having a raised pile surface, the fabric body comprising textured low shrinkage yarns.

The term “low shrinkage yarns,” as used herein, includes fully oriented yarns (FOY), high oriented yarns (HOY) and other yarns having a skein shrinkage in boiled water of less than about 10%, but does not include partially oriented yarns (POY). The fabrics disclosed herein have a pile height of at least about 4 mm.

In some implementations, the fabrics have a pile height of greater than 4 mm, e.g., greater than 4.5 mm or even 4.7 mm or higher. In some fabrics, the low shrinkage yarns are used as pile yarns. Some fabrics are knitted, e.g., circular knit or warp knit. In other cases, the fabric is woven, for example a woven velvet. Some fabrics have regions having different insulative properties, e.g., regions of relatively higher and lower pile heights. The regions may be determined based on body mapping considerations, i.e., in some cases the fabric includes predetermined discrete regions of contrasting insulative capacity positioned about the article in an arrangement having correlation to insulative requirements of corresponding regions of a user's body. One or both faces of the fabric may have a pile surface.

The details of one or more embodiments of the invention are set forth in the description below. Other features and advantages of the invention will be apparent from the description and from the claims.

### DETAILED DESCRIPTION

Preferred fabrics are high pile knitted or woven fabrics that include textured low shrinkage pile yarns.

Suitable pile yarns include textured FOY and HOY yarns. Texturing these yarns imparts a small amount of crimp to the yarns. The yarns are generally synthetic polymeric yarns, e.g., 100% polyester yarns. A preferred yarn is textured 212/94 T-659 yarn with a ribbon cross section, a polyester yarn commercially available from DuPont under the trademark SOFTEC®. The skein shrinkage in boiled water of this yarn is about 4%. Other suitable yarns include high elongation, low tenacity yarns, which have been textured. In some implementations, the yarn has an elongation of about 10% to about 60%, and tenacity of about 2.0 to about 3.5 gpd (grams of breaking strength per denier). Preferred yarns exhibit a skein shrinkage in boiled water of less than 7%, more preferably 5% or less. The yarns are textured using conventional texturing processes, for example false twist texturing, disk texturing, and friction texturing. The amount of crimp retained by the yarn after texturing is generally less than the crimp that would be retained by a similar POY yarn. However, the degree of crimp has been found to be adequate to impart desirable properties when the yarns are used in high pile fabrics.

The pile yarns, backing yarns and stitch yarns of the fabric, which may be double needle bar warp knit, can be the same, or the backing yarns and stitch yarns can be different. Suitable stitch yarns include 70/34 Tx to 150/34 Tx yarns, preferably 100/34 Tx. Suitable backing yarns include 100/34 Tx to 300/34 Tx yarns, preferably 150/34 Tx.

The fabric may have any appropriate construction. Suitable fabric constructions include circular knit, warp knit and woven. The pile may be formed, in circular knit constructions, by cutting the loop yarn on the knitting machine, or by utilizing a sinker loop terry knit construction in which high sinkers are cut during the finishing process. Warp knit fabrics with a pile surface may be produced on a double bar needle Raschel machine, e.g., as described in U.S. Pat. Nos. 6,196,032, 6,199,410, 6,832,497 and 6,837,078, the full disclosures of which are incorporated by reference herein. Suitable woven fabrics have at least one raised pile surface, e.g., woven velvets.

The fabric may have single face pile or double face pile. The fabric may also include regions of low pile and/or no pile, which may in some cases be arranged according to body mapping considerations. Such pile patterns are described in U.S. Ser. No. 60/682,695 and U.S. Ser. No. 11/348,427, the complete disclosures of which are incorporated by reference herein.

### EXAMPLE

Three fabric swatches were manufactured, using substantially identical manufacturing processes. The swatches were warp knit in a double needle bar Raschel process, with the pile being generated by splitting the interconnecting yarns, as described, e.g., in U.S. Pat. Nos. 6,832,497, 6,196,032 and 6,199,410. Similar results can be obtained by circular knitting and cutting the loops to form the pile, as described in U.S. Pat. No. 6,131,419. The yarns used in the samples, and the resulting characteristics of the samples, were as follows:

(1) Comparative Example using textured POY yarn:

This sample was made of standard 150/68 textured polyester yarn, dyed in package dyeing on dye tubes. (Standard texturing of POY yarn). The skein shrinkage of this yarn in boiled water was 14.5%.

The finished fabric had good cover factor and resiliency, but was dull, lacked free movement of the pile, had a dry hand, and exhibited excessive friction (fabric to fabric), which would tend to make a garment containing the fabric difficult to take off and put on.

(2) Comparative Example using non-textured FOY yarn:

This sample was made of 212/94 T-659, flat polyester yarn with a ribbon cross-section. The skein shrinkage of this yarn in boiled water was 2.82%. The fabric was piece-dyed.

The finished fabric was shiny, had a high luster, exhibited free movement of the pile, and low friction fabric to fabric. However, the fabric had a low cover factor, to the extent that the pile was see-through.

(3) Example using textured FOY yarn:

This sample was made of 212/94 T-659 polyester yarn which had been textured. The skein shrinkage of this yarn in boiled water was 4%.

The finished fabric had good cover factor and resiliency, as well as good flow of the pile, soft hand, and low friction fabric to fabric. Thus, this fabric combined the desirable attributes of samples (1) and (2), without the disadvantage of either sample.

A number of embodiments of the invention have been described. Nevertheless, it will be understood that various modifications may be made without departing from the spirit and scope of the invention. Accordingly, other embodiments are within the scope of the following claims.

What is claimed is:

1. A high pile fabric comprising
a fabric body having a technical face and a technical back, at least one of the technical face and technical back having a raised pile surface;
the fabric body comprising textured low shrinkage yarns.

2. The fabric of claim 1 wherein the textured low shrinkage yarns are selected from the group consisting of FOY yarns and HOY yarns.

3. The fabric of claim 1 wherein the pile surface has a pile height of 4.0 mm or higher.

4. The fabric of claim 1 wherein the textured low shrinkage yarns are pile yarns.

5. The fabric of claim 4 wherein the pile yarns comprises synthetic yarns.

6. The fabric of claim 5 wherein the synthetic yarns comprise polyester yarns.

7. The fabric of claim 4 wherein the textured low shrinkage pile yarns have a skein shrinkage in boiled water of less than 7%.

8. The fabric of claim 1 wherein the fabric body has a knit construction.

9. The fabric of claim 8 wherein the fabric body is warp knit.

10. The fabric of claim 9 wherein the fabric body is double needle bar warp knit.

11. The fabric of claim 9 wherein the fabric body is sinker loop terry circular knit.

12. The fabric of claim 1 wherein the fabric body comprises a woven velvet.

13. The fabric of claim 1 wherein the fabric body includes regions having contrasting insulative properties.

14. The fabric of claim 13 wherein the fabric body includes regions of contrasting pile heights.

15. The fabric of claim 1 wherein the fabric body includes predetermined discrete regions of contrasting insulative capacity positioned about the article in an arrangement having correlation to insulative requirements of corresponding regions of a user's body.

16. The fabric of claim 1 wherein at least one of the technical face and technical back has a pile surface.

17. The fabric of claim 16 wherein both the technical face and technical back have a pile surface.

18. A method of forming a high pile fabric comprising:
texturing a low shrinkage yarn to impart a degree of crimp to the yarn;
forming a fabric body using the textured yarn; and
treating a surface of the fabric body to form pile at the surface.

19. The method of claim 18 wherein the low shrinkage yarn is selected from FOY and HOY yarns.

20. The method of claim 18 wherein the forming step comprises knitting.

21. The method of claim 20 wherein knitting comprises circular knitting.

22. The method of claim 21 wherein the treating step comprises cutting loops.

23. The method of claim 20 wherein knitting comprises warp knitting.

24. The method of claim 18 wherein the forming step comprises weaving.

25. The method of claim 18 wherein the treating step comprises forming a pile surface having a pile height of 4.0 mm or greater.
